(19) United States
(12) Patent Application Publication
(10) Pub. No.: US 2006/0248758 A1
(43) Pub. Date: Nov. 9, 2006

(54) Large external LCD monitor sign for street-side display of gas station prices

(76) Inventor: Ray J. Nolte, St. Louis, MO (US)

Correspondence Address: RAY J. NOLTE, 2403 TELEGRAPH ROAD, ST. LOUIS, MO, 63125, US

(21) Appl. No.: 11/405,715

(22) Filed: Apr. 18, 2006

Related U.S. Application Data
(60) Provisional application No. 60/674,659, filed on Apr. 26, 2005.

(51) Int. Cl. G09F 9/37

(52) U.S. Cl. 40/446

(57) ABSTRACT

A large external LCD Monitor Sign for street-side display of gas station prices and any number of images, and prices, with audio, on products the manager of the gas station wishes to offer for sale that day.

CROSS-REFERENCE to my PROVISIONAL Patent APPL No. 60/674,659 with filing date of Apr. 26, 2005 and Title:

Exterior liquid crystal display sign for use by gas stations to advertise prices of their various grades of gasoline, and other products.

### FIELD OF THE INVENTION

This invention relates specifically to eliminating the tremendous number of man hours wasted every week by gas station employees who must manually change the prices of all three grades of gas to stay in competition with the gas station down the block, or to cut the competition's price in an attempt to gain more customers. This is accomplished with a computer, conventional software, and large external LCD monitors. In daily time spent changing gas prices, twenty minutes is reduced to twenty seconds. Gas stations have expanded to selling snack items, and things confectionaries used to handle. These 24 hour advertisement monitors will expand the area of selling food and drug store items at gas stations to untold dimensions.

### BACKGROUND OF THE INVENTION

Many gas stations now have large pylon type signs at the street side on either end of their premises. Competition is rather fierce, and lowering prices by a cent or two often is the only way to stay in business. Competition will meet your price, and the next day he will undercut your price. Forever changing numerals on these large signs, high in the air, is a tedious, time consuming business.

In the early days when traveling you watched for signs painted on barns to learn how many miles to the next gas station, and competition was nonexistent. If the man charged six cents, or seven cents, or eight cents a gallon, when you were paying a nickel in the city, you were happy to pay because he was out there where he was needed. You knew that without him, you would be on horseback, or stagecoach.

And times change; more gas stations, and larger higher signs displaying ever higher gas prices. About a half-century ago, a price sign was invented for gas stations using individual white numerals, each painted on a rectangular black metal background. Each numeral had a hole about an inch down from the top and centered between the two side edges. On the sign, each numeral hung on a small stud pin in its proper place, to display that numeral of the gas price. Prices were changed with a long pole having what looked like a nail protruding from the far end. That nail was placed in the hole in the top area of the numeral and raised upward to lift the numeral off the stud from which it was hanging. The numeral for the new price was then placed on the nail in the pole and raised above the stud and with a little wiggle movement of the pole, the numeral was slid onto the stud, and the new price was displayed. There was also a type of pole that had a small pivot mechanism operated by pulling a string to ease the numeral away from the pole and onto the stud.

That mechanism has been replaced many years ago with what many stations still considered the most modern method. The stud, the hole in the numeral, and the nail on the pole, are no longer used. The most modern method uses a suction cup on the end of the pole. The numeral is still a large white number on a rectangular black background, but instead of metal, the background is black plastic. The stud has been replaced with a small trough, a part of the sign, that the bottom of the numeral rests in, and there is a deeper trough in the area above the numeral so that the numeral is held between the upper and lower troughs. Removal of the numeral is accomplished by dampening the suction cup on the pole, and raising the suction cup to physically contact the surface of the numeral and then raising the numeral above the lower trough and higher into the upper trough, then moving it outward away from the sign to complete the removal of that one numeral. To install the new price, the new price numeral is then held by the suction cup attached to the long pole, and raised into the upper trough and lowered into the bottom trough, thereby enabling the suction cup to be slid down and away from the sign, leaving the numeral held in place by its position between the upper and lower troughs.

There is a more recent gas station price sign. It is a rather large hollow white plastic sign with lighting on the inside. It uses large black numerals that show up well on the white lighted background, but these numerals must also be manually replaced. I believe the advantage is that the lighted white background, not so high off the ground shows the black numerals well and they can be more easily replaced with a long ladder, rather than the pole.

### DESCRIPTION OF THE INVENTION

This invention uses a standard desktop computer, with conventional software to display on a very large LCD, Plasma, or other suitable large screen Monitor, right out near the curb where the people are driving by, the daily price of the various grades of gasoline offered for sale by the owner of the gas station. The very large TV size monitor replaces the large sign, presently at gas stations, whose numerals are now manually changed almost daily in highly populated, price competitive areas. In addition to displaying the price of gasoline in the upper corner of the monitor screen, these large forever-moving advertisement style external monitors, with audio, literally open the gas station to the general public and invite the people to come inside. Preferable use replaces the double, back to back, gas price signs in use today, which can be read from traffic approaching the gas station from either direction, with two of our large external LCD style monitors placed back to back so that one LCD sign, or the other, can be read from traffic approaching the gas station from either direction. These monitors would preferably be placed curb-side on a concrete base suitable to keep them above running rainwater.

We describe these as external LCD, or Plasma, monitors to the extent that while functioning normally indoors, when placed outside near the street where their advertisements will be more noticeable, they will require total protection from the weather, including heating and air conditioning, with temperature and moisture controls.

The gas station owner could choose icons of items he has for sale, and proper prices, from the software lists included to easily display on both monitors, or he can display different items on each monitor. The software would include full audio and video adjustments. He can run these advertisement displays continuously 24/7, or any specific hours he desires. He could get animated displays from beer, soda, chip and dip companies, and if he wants to sell sandals and shoes, those companies will provide him with software advertising clips. He can also attract new customers by offering free advertising to churches and schools in the area. He could also sell advertising space to local businesses. These advertisement monitors are applicable to other retail businesses also.

### DRAWINGS

FIG. 1 is the screen of an active LCD Monitor Gas Price Sign with gas prices and basic 24/7 continuous advertisement icons.

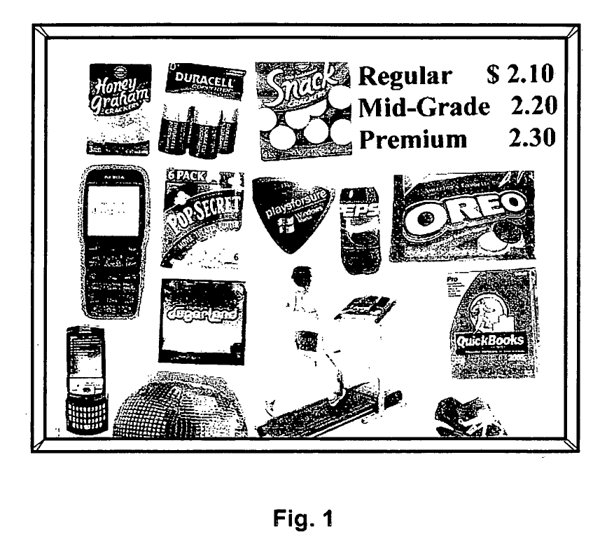

FIG. 2 is a single LCD Street-side Monitor in inactive mode. This sign will require weather protective housing with heat and air conditioning and temperature and humidity control.

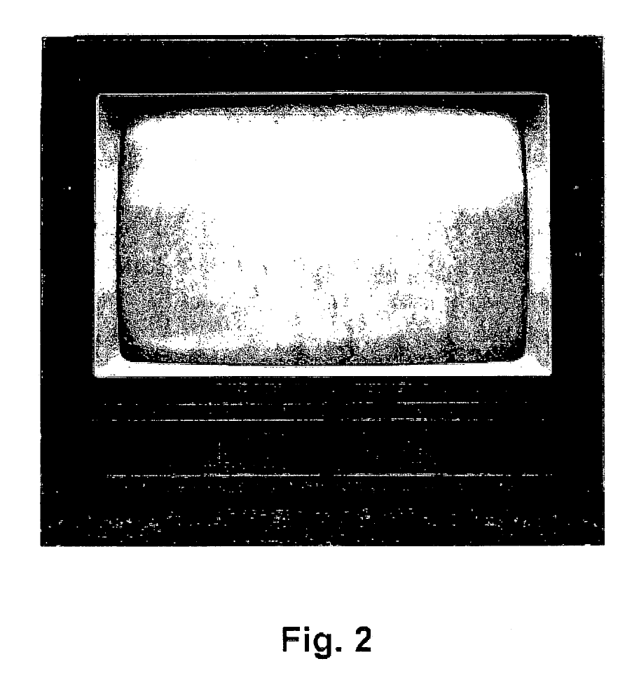

I Claim:

1. An external price sign for gas stations which is comprised of a computer controlled Liquid Crystal Display (LCD), or Plasma, or similar type monitor for use by gas stations to advertise the prices of their various grades of gasoline.

2. The price sign according to claim 1 can be located external from the building housing the computer.

3. The price sign according to claim 1 being located at an area of the gas station easily viewable by traffic from any direction.

4. The price sign according to claim 1 being physically connected to the computer by cable means, or connected by wireless means.

5. The price sign according to claim 1 being located curbside (close to the street) for optimum viewing.

6. The price sign according to claim 5 being a single sign for viewing from one direction, or two signs, back to back for viewing from two, or more, directions.

7. The price sign according to claim 6 being converted to an external sign of the same type, by being suitably packaged to form a tight, weatherproof, temperature and humidity controlled, waterproof unit with clear plastic, or glass, panels protecting the viewable monitor screens, properly controlled heating for the cold weather and air conditioning for the hot weather to maintain the temperature and humidity requirements of all elements.

8. The price sign according to claim 7 being located on a concrete slab designed to position the external sign high enough above the land, or road level, to protect it from rushing rainwater.

9. A price sign according to claims 1 through 7 being of sufficient size that the large size gas prices shown in one upper corner of each sign, easily readable by oncoming traffic, uses no more than twenty percent of the monitor's screen viewing area.

10. The sign according to claim 9 using no more than twenty percent of the monitor screen viewing area for gas prices, leaves the remaining area of the monitor screen available for whatever the gas station owner chooses to advertise in that area, as long as it is within the law.

11. The sign according to claim 10 can be used by its owner to advertise any items he wishes to advertise, be it photos of anything, icons of anything, animations of anything, and a display of anything else he wishes to display on the monitor screen as long as it is within Federal, State, City, and Local Community laws.

12. The sign according to claim 11 can be used by its owner to advertise any items, twenty-four hours a day, seven days a week, fifty-two weeks a year, or any type of partial days required for his business.

13. The sign according to claim 12 which can be used by its owner to advertise any items externally, or internally, for whatever business the owner may be in.

14. An external advertisement sign comprised of a computer controlled Liquid Crystal Display (LCD), or Plasma, or other suitable type, monitor, being located external from the building housing the computer, and being suitably packaged to form a tight, weatherproof, temperature and humidity controlled, waterproof unit with clear plastic, or glass, panels protecting the viewable monitor screens, and with properly controlled heating for the cold weather and air conditioning for the hot weather to maintain the temperature and humidity requirements of all elements.
